(19) United States
(12) Patent Application Publication
(10) Pub. No.: US 2016/0202111 A1
(43) Pub. Date: Jul. 14, 2016

(54) CONTAINER LIFT AND/OR WEIGHING SYSTEM

(71) Applicant: BISON GROUPL LIMITED, Dunedin Central, Dunedin (NZ)

(72) Inventors: Mark James FAHEY, Mosgiel (NZ); Gregory John McDermott FAHEY, Dunedin (NZ); Carsten Heinrich MUELLER, Kerikeri (NZ)

(21) Appl. No.: 14/913,016

(22) PCT Filed: Aug. 21, 2014
(86) PCT No.: PCT/NZ2014/000174

§ 371 Date: Feb. 19, 2016

(30) Foreign Application Priority Data
Aug. 21, 2013 (NZ) 614578

(51) Int. Cl. G01G 19/10; B66F 3/24; B66F 3/46

(52) U.S. Cl. CPC G01G 19/10; B66F 3/46; B66F 3/24

(57) ABSTRACT

A portable container lift or weighing system includes lifting units, each including a hydraulic linear actuator and a mounting arrangement for mounting the actuator to a shipping container. The system includes a number of portable components that can be handled by a single worker. The system may provide a means for weighing the container.

### FIELD OF THE INVENTION

The invention relates to systems for lifting and/or weighing containers, particularly shipping containers.

### BACKGROUND TO THE INVENTION

Shipping containers are widely used for transport of goods. Containers are stacked on large freight ships and may also be transported by train or truck. These containers are substantially standardised, although there can be variations depending on the size and type of goods transported inside the container.

These containers have empty weights from 2,200 kg to 4,800 kg and maximum gross weights (including the container itself) of around 30,000 kg.

The convenience and efficiency provided by the use of ISO standardised containers for freight handling has led to their ubiquitous use throughout the world, on ocean, railroad and road. The handling of containers does not pose a particular problem when suitable infrastructure such as cranes, straddle carriers, reach-stackers or large forklifts are available, for example in hubs such as train yards, container terminals and large distribution centres. However this heavy duty equipment is typically capital intensive and is not always suited, or able to be efficiently transported, to the many locations at which containers are packed, unpacked or otherwise handled.

Various mobile equipment is used to facilitate container transport to and handling at these locations. Mainstream examples of this equipment include: (i) specialised self-loading container trailers, often called side loaders; (ii) truck cranes, housed on a truck deck that can lift both containers and other goods on and off the deck; and (iii) tilt bed or tilt deck trailers, which have a tilt function and winch that allows a container to slide on or off the trailer.

All of the heavy duty container handling equipment described above suffers from a variety of limitations, which may include: (i) high cost; (ii) lack of portability; (iii) high tare weight; (iv) inability to handle heavy containers; (v) inability to handle all container types; (vi) requirement of a high or wide space in which to operate; (vii) requirement of a concrete or other reinforced surface on which to operate; (viii) failure to keep the container and its contents level; and (ix) failure to measure, record or communicate the container's weight.

A container's weight properties are important at many points in the logistics chain, particularly in connection with safety and efficiency of container transportation on road, rail and seas, as well as for ensuring regulatory compliance in many countries. Despite this, many containers are transported with no measurement or verification of the container's weight. Widespread concern relating to unknown or mis-declared container weights has prompted the International Maritime Organization's Sub-Committee on Dangerous Goods, Solid Cargoes and Containers to develop new regulations that will, if adopted, require shippers globally to verify the weight of each container before it can be accepted for loading on to a vessel.

The weight of cargo within a container is essential information in many industries where the cargo is traded on the basis of its weight. For some types of cargo, such as recycled metal and other waste, the net weight of the cargo is sometimes extrapolated from the gross weight of the laden container.

The weight of containers and containerized freight can be measured using industrial weighing equipment, either incorporated into cranes and other lifting apparatus, or by dedicated fixed infrastructure such as weigh bridges.

Such industrial weighing equipment can be large and expensive to buy, install and maintain. Industrial weighing equipment is often fixed in a single location, requiring the container to be diverted to and detained at that location. Sometimes such equipment does not offer the level of weighing accuracy or carry necessary calibration or certification credentials required by interested parties. A typical feature of most conventional container weighing equipment is that it must be integrated into or used in conjunction with heavy and expensive container handling or haulage infrastructure, such as cranes, straddle carriers or trucks and trailers.

These characteristics can make it impractical or uneconomic for shippers to measure the weight of containers (or containerised freight) at their premises. It would be desirable for some shippers to have this option, given the opportunity it would afford them to: (i) optimise container shipments, (ii) avoid the cost of diverting containers to third party weighing stations; (iii) ensure the container is safe for transportation, (iv) avoid the cost and disruption of having a container identified as overweight after it is packed and dispatched, and (v) to comply with land transport, maritime and other regulations that relate to container weights and safety.

For the purpose of transferring shipping containers to and from truck trailers, there have been several attempts at producing a container lifting system with four vertical columns that attach to the corners of an ISO shipping container and provide lifting functionality. These systems can be broadly divided into two sub-categories based on the method by which the load for lifting the container is generated; namely by mechanical means or by hydraulic means. Systems employing a mechanical means for creating the axial load are disclosed in U.S. Pat. No. 4,148,511, U.S. Pat. No. 4,619,439, U.S. Pat. No. 5,170,994 and U.S. Pat. No. 7,100,896. In these cases a power-screw which is driven manually or by an electric motor is used. An alternative mechanical means to a power-screw is a rack and pinion, as disclosed in U.S. Pat. No. 4,190,135. Systems using hydraulic means are disclosed in U.S. Pat. No. 3,289,868, U.S. Pat. No. 3,327,996, U.S. Pat. No. 3,749,363, U.S. Pat. No. 4,248,467, U.S. Pat. No. 4,903,946 and U.S. Pat. No. 5,800,114.

One disadvantage common to the mechanical-type lifting system is that all lifting devices must work synchronously. Failure to operate the lifting devices synchronously will cause uneven load sharing by the lifting devices, and potentially an excessive load to be applied on two of the lifting devices. As a consequence of this, the rated load capacity of the mechanical-type lifting system may need to be twice the maximum rated payload to safeguard against the case where the payload is carried on just two of the four lifting devices at diagonally opposite corners of the container. This redundancy is not optimal regarding the desired lightweight characteristic for such lifting devices, because the structure is then designed for twice the nominal payload, in order to cover the case that the load be unevenly shared by all four lifting devices. The issue of even load sharing is relevant to the hydraulic-type lifting system too, but there are means for counteracting this behaviour with the hydraulic circuitry, such as pressure relief valves.

A disadvantage of mechanical-type lifting systems that are operated manually is that they require the cooperation of multiple people, stationed close to the elevated container, to operate the lifting devices synchronously. A further disadvantage is that a relatively long time and physical exertion is required to manually raise a fully loaded container to the necessary height.

In comparison, hydraulic-type lifting systems introduce another degree of complexity over the mechanical-type lifting systems, as hydraulic pumps, circuitry and sealing elements are required. However these quantities are well known and understood by those skilled in the art, and there are sufficient benefits to warrant the use of hydraulics.

One limitation of all known prior art, both mechanical and hydraulic-type, is the size and weight of the lifting device itself and in particular the challenges that this poses when transporting and handling the lifting device. The size and weight of the lifting device influences the method, the relative ease, time frame and the safety of the attachment and detachment process.

In the case of U.S. Pat. No. 4,248,467 each lifting device weighs around 660 kg. A forklift is required to position the four lifting devices at the corners of the container for attachment. In U.S. Pat. No. 4,903,946 it is mentioned that the weight of the lifting device can reach about 300 kg. These weights cannot be handled manually and add considerable tare to a vehicle if transported. There is a significant risk of bodily harm posed to the operator if such a heavy lifting device were to topple during handling.

It is desirable therefore, for a lifting system that is transported and manually handled to be lightweight. One method of reducing weight relies on the substitution of materials with alternatives that have a higher strength to density ratio. For example, lightweight metal alloys and fibre-reinforced composite materials may be used instead of steels. Using materials with a higher strength to density ratio allows either less material to be used, or a less dense material to be used, without compromising function.

Yet another limitation of existing container lifting systems with four vertical columns is that they are not configured to determine and provide the weight characteristics of the container being lifted.

It is an object of the invention to provide an improved container lifting and/or weighing system, which addresses at least some of the various limitations of existing container handling and/or industrial weighing equipment cited above, or at least to provide the public with a useful choice.

### SUMMARY OF THE INVENTION

In a first aspect the invention provides a shipping container weighing system, including a plurality of portable weighing units, each weighing unit including: a base; an engagement arrangement configured to engage with a shipping container; an adjustable height element mounted on and extending upwards from the base, the engagement arrangement being mounted on the adjustable height element, wherein the adjustable height element can be driven to extend in order to lift the container; a sensor configured to sense load or force applied to the weighing unit by the shipping container when it is supported by the portable weighing units.

Preferably the adjustable height element includes a linear actuator. Preferably the linear actuator is a hydraulic actuator.

Preferably the base includes an articulated foot plate.

Preferably each portable weighing unit includes a wheeled sub-structure for mobility.

Preferably the system includes a controller.

Preferably the controller is configured to determine one or more weight properties of the container. Preferably the weight properties include one or more of: weight sensed by the individual weighing units, total container weight, weight distribution, and centre of mass.

Preferably the controller is configured to associate container weight data with one or more of: time, date, location, container ID, container seal number, cargo information, shipping information, name of shipper, and image data.

Preferably the controller is configured to transmit gathered data to a remote computer, database or cloud storage.

Preferably the controller is configured to control adjustment of the adjustable height element of each weighing unit. Preferably the controller is configured to control adjustment of the adjustable height element of each weighing unit such that the heights of the weighing units are adjusted synchronously. Alternatively, the controller is configured to control adjustment of the adjustable height element of each weighing unit in order to alter the orientation of the container.

Preferably each weighing unit further includes a height sensor and is configured to communicate sensed height data to the controller.

Preferably the controller is or includes a wireless handheld control unit.

Preferably the controller is configured to implement a verification process in order to verify that weight data has been properly obtained without tampering.

In a further aspect, the invention provides, in a container lifting and/or weighing system, an engagement arrangement including: a first engagement element configured to engage with a standard fitting or fittings of a shipping container; a second engagement element configured to receive, in use, an upper end of an adjustable height element such that, in use, the adjustable height element can be driven to extend in order to lift the container; and a sensor configured to sense load or force applied by the shipping container when it is supported by the engagement arrangement.

Preferably the sensor is mounted in the second engagement element. Preferably the second engagement element includes a housing configured to receive the upper end of the adjustable height element and to align the upper end of the adjustable height element with the sensor.

This aspect also extends to a system including such an engagement element and a controller.

Preferably the controller is configured to determine one or more weight properties of the container. Preferably the weight properties include one or more of: weight sensed by the individual weighing units, total container weight, weight distribution, and centre of mass.

Preferably the controller is configured to associate container weight data with one or more of: time, date, location, container ID, container seal number, cargo information, shipping information, name of shipper, and image data.

Preferably the controller is configured to transmit gathered data to a remote computer, database or cloud storage.

Preferably the controller is or includes a wireless handheld control unit.

Preferably the controller is configured to implement a verification process in order to verify that weight data has been properly obtained without tampering.

In another aspect the invention provides a shipping container lift system, including three or more portable lift units, each lift unit including: a base; an adjustable height column mounted on and extending upwards from the base; a mounting arrangement including a first portion mounted to the column at a point spaced below a top portion of the column, a second portion extending from the first portion away from the axis of the column, and a twist-lock fitting mounted on the second portion and configured for engagement with a corresponding twist-lock fitting on a bottom corner of a shipping container; and a flexible tensile element extending between the second portion of the mounting arrangement and the top portion of the column; wherein, in use, the mounting arrangements of the portable lift units can be engaged with the shipping container and the adjustable height columns extended or retracted to lift or lower the shipping container.

Preferably the flexible tensile element is a cable, wire, strap or chain. Preferably the flexible tensile element is attached at its first and second ends to either the second portion of the mounting arrangement or the top portion of the column, a mid-point of the flexible tensile element extending around the other of the top portion of the column and the second portion of the mounting arrangement.

Preferably the adjustable height column includes a linear actuator configured to drive the height adjustment. Preferably the linear actuator is a hydraulic actuator.

Preferably the adjustable height column includes two telescoping tubes of different diameters arranged concentrically.

Preferably the system includes sliding elements that maintain the concentricity of the two tubes as they slide relative to each other. Preferably the linear actuator is mounted inside the telescoping tubes and provides a means for the telescopic actuation.

Preferably the base includes an articulated foot plate.

Preferably, in use, the mounting arrangements of the portable lift units can be engaged with the shipping container and the hydraulic cylinder extended to lift the shipping container to a sufficient height for passing a truck or trailer underneath.

Preferably each portable lift unit includes a wheeled sub-structure for mobility.

Preferably the wheeled sub-structure is powered.

Preferably the system includes an upper container support mounted above the mounting arrangement on the adjustable height column. Preferably the upper container support includes an L-shaped portion configured to engage side and end walls of the container.

Preferably the system includes a controller.

Preferably each lift unit further includes a sensor configured to sense load or force applied to the lift unit by the shipping container when it is supported by the lift units.

Preferably the controller is configured to receive data from the sensors and to determine one or more weight properties of the container from the sensed loads or forces. Preferably the weight properties include one or more of: weight sensed by the individual weighing units, total container weight, weight distribution, and centre of mass.

Preferably the controller is configured to associate container weight data with one or more of: time, date, location, container ID, container seal number, cargo information, shipping information, name of shipper, and image data.

Preferably the controller is configured to transmit gathered data to a remote computer, database or cloud storage.

Preferably the controller is configured to control adjustment of the adjustable height column of each lift unit.

Preferably the controller is configured to control adjustment of the adjustable height column of each lift unit such that the heights of the lift units are adjusted synchronously. Alternatively, the controller is configured to control adjustment of the adjustable height column of each lift unit in order to alter the orientation of the container.

Preferably each lift unit further includes a height sensor and is configured to communicate sensed height data to the controller.

Preferably the controller is or includes a wireless handheld control unit.

In a further aspect the invention provides a shipping container lift system, including three or more portable lift units, each lift unit including: a base; an adjustable height column mounted on and extending upwards from the base; a mounting arrangement including a first portion mounted to the column at a point spaced below a top portion of the column, a second portion extending from the first portion away from the axis of the column, and a twist-lock fitting mounted on the second portion and configured for engagement with a corresponding lower twist-lock fitting on a bottom corner of a shipping container; and a bracing strap, wire, cable or chain configured, in use, to attach to an upper twist-lock fitting of the shipping container, a top portion of the adjustable height column and a bracing point located at or near the bottom of the container or on another lift unit; wherein, in use, the mounting arrangements of the portable lift units can be engaged with the shipping container, the bracing straps, wires, cables or chains attached and the adjustable height column extended or retracted to lift or lower the shipping container.

### BRIEF DESCRIPTION OF THE DRAWINGS

The invention will now be described by way of example only, with reference to the accompanying drawings, in which:

FIG. 1 shows a shipping container lift system according to one embodiment, mounted to a shipping container which is located on a truck-trailer;

FIG. 2 shows the lifting devices of the system of FIG. 1, in an extended position;

FIG. 3 shows the lifting devices of the system of FIG. 1, in a retracted position;

FIG. 4 shows the lifting devices of the system of FIG. 1 with a steel-rope for bracing;

FIG. 5 shows a lifting device of the system of FIG. 1 including the trolley for portability;

FIG. 6 shows a lifting device of the system of FIG. 1 without the trolley;

FIG. 7 shows a cut-away view of lifting device of the system of FIG. 1 in a slightly extended configuration;

FIG. 8 shows another embodiment of the lifting device, with a reduced lifting height;

FIG. 9 shows a lifting device of the system of FIG. 8 mounted to a shipping container for the function of determining the container's weight;

FIG. 10 shows a further embodiment of the lifting device;

FIG. 11 is a detailed view of the twist lock fitting in the device of FIG. 10;

FIG. 12 shows the device of FIG. 10 in a stowed or folded position;

FIG. 13 shows a control system according to one embodiment;

FIG. 14 shows a further embodiment of lifting device, primarily intended for weighing containers;

FIG. 15 is an exploded view showing components of the device of FIG. 14;

FIG. 16 is a bottom view of the mounting bracket of the device of FIG. 14;

FIG. 17 shows four devices of FIG. 14 mounted to a shipping container;

FIG. 18 shows a further embodiment of lifting and/or weighing device;

FIG. 19 shows devices according to FIG. 18 mounted to a container on a trailer;

FIG. 20 shows a mounting portion according to another embodiment; and

FIG. 21 shows a lifting and/or weighing device including the mounting portion of FIG. 20.

### DETAILED DESCRIPTION

The Applicant has invented a novel system for lifting and/or weighing shipping containers.

In its simplest form, the system can attach to the four corners of a container and lift the container a small height off the ground, enabling the weight at each corner of the container to be measured by sensors and for the weight data to be collected and used by the operator. In a more sophisticated form, the system can be attached to the four corners of a container and, in addition to having weighing functionality, the system can be used to vertically raise or lower the container at heights sufficient to enable the container to be transferred between the ground and an elevated platform, such as a trailer or support frame (for example by backing the trailer under the lifted container).

The container lifting and/or weighing system is novel in its combination of weight, size, portability, ease of handling, method of attachment to the container, versatility across different container types, weights and dimensions,the functionality of its control and information systems, and its ability to lift and weigh the container. The more sophisticated embodiment of the system comprises of a set of lightweight, hydraulically actuated lifting legs that can be attached to the shipping container and used to vertically raise or lower the container. The container can then be positioned on a trailer (for example by backing the trailer under the lifted container) or on a support frame, or lowered to the ground. Throughout the vertical movement, the hydraulic actuators maintain the floor of the container in a substantially horizontal orientation.

The invention provides specialised lifting legs. These lifting legs are attached to standard features of containers, such as the corner fittings present in ISO containers, and enable the container to be raised vertically to a height that allows a truck-trailer to be positioned or removed from under the container. The lifting legs can also be lowered and the container placed on the trailer or on the ground.

The Applicant's lifting legs can be attached to the corners of the container by a single person without the need for a forklift or other such equipment.

The system has the capacity to lift a fully loaded container weighing around 30 tonnes with an assumed weight distribution such that the centre of gravity is at the maximum allowable offset from the geometric centre. The lifting devices can handle the wide variety of containers that are in current use, for example, with lengths of 10′, 20′, 40′ and 45′, 48′ and 53′ and heights of 8′, 8′6″ or 9′6″, and widths of 8′ and the different ISO container types including dry van, reefer and tank containers.

The Applicant's system can be used for transferring the container between the ground and a trailer, or from trailer to trailer, with wide clearance between the lifting devices to make it easy to reverse a trailer under an elevated container. Alternatively the container can be deposited on to a support frame allowing the container to be positioned, for example, at a loading dock. The support frame may be mobile or stationary.

The Applicant's lifting units are capable of lifting a container from ground level to a height of around 1.75 m, sufficient to lift the container onto typical trucks and trailers. The system may be adapted to other heights as necessary. For example, only a short lift height is necessary for a system that is dedicated to a weighing application.

The lifting units are preferably attached to the container using the “twist lock” fittings that are standard features of shipping containers and are well known to those skilled in the art.

Further, the Applicant's lifting units may use wires, cables, straps or other support features to assist the attachment and detachment procedure and to further brace the lifting legs against the container. These wires, cables, straps or other support features provide additional rigidity and further enhance safety. This method has the added advantage of simplifying the design of the attachment of the lifting legs to the container, by eliminating the necessity for the leg attachments to engage directly with the container's upper twist-locks, with convenience, cost and safety advantages. The distance between the upper and lower twist-locks depends on the height of the container (e.g. 8′, 8′6″ or 9′6″), and furthermore experience has shown that containers can become permanently twisted during their lifetime, causing misalignment between the upper and lower twist-locks. The flexibility of the wires, cables or straps in particular eliminates these complications. Further, these wires, cables or straps or other support features may both assist the attachment and detachment procedure as well as brace the lifting legs during use.

However, in alternative embodiments the lifting units may engage directly with the container's upper twist locks in addition to the lower twist locks.

The hydraulic actuators in the Applicant's lifting devices may have an integrated electric motor and hydraulic pump, with the electrical power supplied from an external source or from a power source housed on the device. Alternatively the hydraulic pressure and flow may be supplied by a hydraulic pump fitted to a power take-off shaft on the truck's engine.

The external electrical power source can be from a power supply at the site of operation, or from a portable generator, or from the truck used to transport the container. An alternative embodiment has hydraulic pressure and flow supplied to the actuator by a central hydraulic pump and motor. The external pump may be driven by an electric motor, or by a motor powered by petrol or another fuel. An internal power source may comprise batteries that may be charged from time to time by direct or contactless connection with an external power source.

In some embodiments, each hydraulic actuator may be connected to suitable counter balance valves, providing security against hydraulic failure. Further, where powered operation is to be used, each hydraulic actuator may in addition be configured to connect with a manual hydraulic hand pump to serve as a back up operating mode.

Each lifting device can be extended or retracted independently, allowing the lifting device to be positioned appropriately during attachment and to suit the terrain. An articulated base or foot-plate provides a stable interface with the ground. While the weight of the container is being carried by the lifting devices, the flow of hydraulic oil to or from each actuator must be regulated to ensure that the floor of the container remains substantially horizontal during the lifting or lowering operation. This synchronous motion of the actuators may be performed in open-loop fashion with an appropriately designed hydraulic circuit, for example, through the use of a flow divider. Alternatively the synchronous motion may be obtained with a closed-loop electro-hydraulic control system.

The feedback for closed-loop electro-hydraulic control system may come from tilt sensors. Such sensors can detect the gravity vector and provide an output signal that relates to the angle of tilt about two horizontal axes. This signal can be used to determine the appropriate action for the valves that regulate the hydraulic actuators. For example, if the floor of the container is not horizontal, this will be detected by the sensor or sensors, and the motion of the actuators adjusted to return the container floor to horizontal.

An alternative means for providing an input to the control system is with height sensors that measure the extension of each lifting device. The control system would seek to ensure the same rate of change in length for each lifting device. The control system may use the input from both tilt sensors and height sensors, as well as any other appropriate sensor. Other sensors that may be employed include, for example, pressure transducers for measuring the hydraulic pressure in the actuator, or load cells, and thereby determining the weight of the payload. In addition, or alternatively, load or weight information can be obtained from suitable sensors monitoring the current draw and/or back EMF of the electric motor powering the hydraulic pump.

There may be occasions when having the container floor in a non-horizontal orientation is desirable. For example, tilting the container while it is elevated on the lifting devices causes a lateral movement of the container, and this lateral movement may be used to align the container over the trailer. This function reduces the accuracy with which the trailer must be positioned under the container. The maximum angle of tilt can be limited by the control system.

The electro-hydraulic control system may be connected to the lifting units and/or other devices by any suitable means, including wired or wireless connections, cables and/or wireless transmitters and receivers.

In one embodiment the control system may include a (preferably wireless) hand held remote control with which the operator may control various lift functions and receive information on the system's status and/or the weight properties of the container being handled. The hand held unit may be a Smartphone, tablet or similar device.

The control system may include any suitable arrangement of controller and subcontrollers.

The electronic control system may also include information technology systems that enable firmware upgrades and/or system diagnostics to be performed, either physically or remotely.

In general, the control system has two main functions—to regulate actuation and to gather and/or process the output data. One function or the other may be provided, or both functions may be provided. In some embodiments, for example in a dedicated container weighing system, the lifting function may be actuated manually but the control system may still provide the data output function. In other embodiments, for example a dedicated lifting system with no weighing capability, the control system may not need to handle data.

In this specification the term “controller” will encompass any device or group of devices providing one or both of the above functions. A controller may include electronic components positioned within each lifting and/or weighing unit, as well as other devices such as handheld devices, computers, fixed devices (for example fixed to a truck or to one of the lifting and/or weighing units). The controller may include a main controller and any required number of subcontrollers. Where the controller includes two or more devices, these devices may communicate with each other by any suitable wired or wireless link.

There may or may not be direct communication between the lifting and/or weighing units. In the case where there is no direct communication, a separate control device may be used to gather the individual weight measurements, and process, display and/or distribute weight information. Information may be displayed on any suitable device (whether forming part of the control system or not), including any suitable display, Smartphone, tablet, laptop, computer, handheld unit, or a display positioned on one of the lifting and/or weighing devices.

In one embodiment each lifting and/or weighing unit may include a subcontroller configured to communicate with a handheld device by a short range wireless link (such as Bluetooth or Near Field Communication or similar). The user may carry the handheld device around the container to gather data from each lifting and/or weighing unit. In this case, the system may require the user to gather data from all lifting and/or weighing units and then gather data again from the first lifting and/or weighing unit. This acts as a cross-check or verification step. Any change in the reading from the first unit indicates a change in load, which could result from incorrect operation or an attempt to tamper with the weighing process (for example by lowering the container). Where a change in the reading is detected the system may require the weighing process to be recommenced.

Alternative verification methods may be used. For example, each lifting and/or weighing unit may include a subcontroller capable of monitoring the sensed load over time and verifying that the sensed load has not changed over a given time window. The system may require the operator to gather data from all lifting and/or weighing units within that time window. In other embodiments verification may be based on appropriate monitoring of accelerometers or other devices in the lifting and/or weighing units. Movement sensed during the measurement period may indicate an error or an attempt to tamper with the measurement process.

It should be noted that the lifting system with four actuators has four degrees of freedom; that is each actuator can extend/retract and hence has one degree of freedom. Assuming the container to be a rigid body, the container has three degrees of freedom; these being vertical movement, roll and pitch. Theoretically, and in some practical embodiments, only three actuators would be sufficient to lift the container and be stable. However, where four actuators are used, the control system can be designed to accommodate the additional degree of freedom in the lifting system, for example, by maintaining a minimum pressure to ensure that all four actuators are in contact with the ground and are suitably loaded.

Setting up the lifting devices for operation may include connecting the electrical, electronic control and/or hydraulic lines, depending on the particular embodiment.

The lifting device is designed to achieve the above mentioned functionality with a small number of individual components, thereby achieving maximum inter-operability from the given components.

The lifting devices may be stowed and transported within the truck and trailer, for example, under the trailer or behind the cab. In all situations the lifting devices should be secured appropriately with tie-down devices. Features may be provided on the lifting devices to facilitate this.

Alternatively the lifting devices may be stowed in a light trailer or customised mobile storage system that can be transported by a light vehicle.

The lifting devices and associated components may be collapsible or seperable, to reduce their dimensions for storage and transportation purposes or to make their operation more user friendly.

Features may also be provided to assist with manoeuvring the lifting devices into position, when attaching them to the container, for example, to allow the operator to temporarily secure the lifting device in the standing position before the final attachment. This may include features to improve the ergonomic performance of the lifting system. Suitable features may include suitable poles, hoops, springs, pulleys, hooks, and/or lifting eyes and the use of advantageous leverage. The purpose of such features is to improve safety, speed and ease of use. Similar features may be provided to achieve the same advantages when detaching and storing the lifting devices.

Each lifting device preferably includes a base or footpad that forms the interface between the actuator and the ground. The footpad distributes the load, and the size of the footpad may depend on the terrain or other application-specific considerations. A large footpad is required for soft terrain and a smaller footpad can be used on hard terrain. The footpad may pivot relative to the actuator to accommodate tilting of the lifting devices and uneven ground, and it may be interchangeable.

The base may be connected to a wheeled sub-structure, to give each lifting unit mobility. The base may also be capable of disconnection from the wheeled sub-structure, to facilitate storage, transportation and the lifting of containers in narrow spaces. This sub-structure may house or support all or some of the electric motor, hydraulic pumps, electronic control systems, communications systems and other hardware and software comprising the overall system. Alternatively, or in addition, some of such hardware and software may be housed or integrated within the lifting unit. The sub-structure may provide handles and other features to assist with manoeuvrability and the container attachment and detachment procedures. The wheels on the sub-structure may be powered, to reduce man handling and to speed up operations.

The lifting system may be integrated with information technology systems to record location, time and date, job details, load data, weight properties, performance metrics and other relevant data from the system and to communicate this information to interested persons. In this document, unless the context requires otherwise, the term “load” relates to the force encountered by a single lifting or weighing unit. The term “weight” relates to the weight of a container lifted and/or weighed by the lifting and/or weighing system.

Weight properties may be derived from normal operation of the system via load sensing in the lifting devices. As well as determining the overall weight, various weight distributions and/or the location of the centre of mass of the container may also be calculated. As well as calculating the centre of mass position in the lengthwise and sideways direction, the vertical height of the centre of mass can be determined by slightly rolling or tilting the container with the lifting devices. This may be valuable information for truck drivers, who currently often have very little information as to the distribution and static roll threshold of the load.

Automated systems may also be used to assist with reversing the trailer under the elevated container, for example, a light curtain or a pressure-activated stripe that guides the driver while reversing and sounds a warning alarm if the trailer is at risk of colliding with the lifting devices. Other means of assistance for the driver while reversing and to prevent collision include remote cameras, monitors and proximity sensors.

An alternative application of the system is to provide a portable weighing system, dedicated to determining the weight of containers. For this application the lifting legs only need to lift the container a small height off the ground, and lateral clearance is not needed between the lifting legs for a truck-trailer to pass. Accordingly the lifting legs and hydraulic actuator can be much shorter and lighter, the component parts of each lifting leg may be separable and the attachment and bracing mechanisms can be simplified or dispensed with.

For the avoidance of doubt, references in this document to a “lifting device” or “lifting unit” or “lifting system” are not intended to exclude embodiments that are principally used for weighing. Similarly, references in this document to a “weighing device” or “weighing unit” or “weighing system” are not intended to exclude embodiments that are principally used for lifting a container between the ground and an elevated platform, such as a trailer.

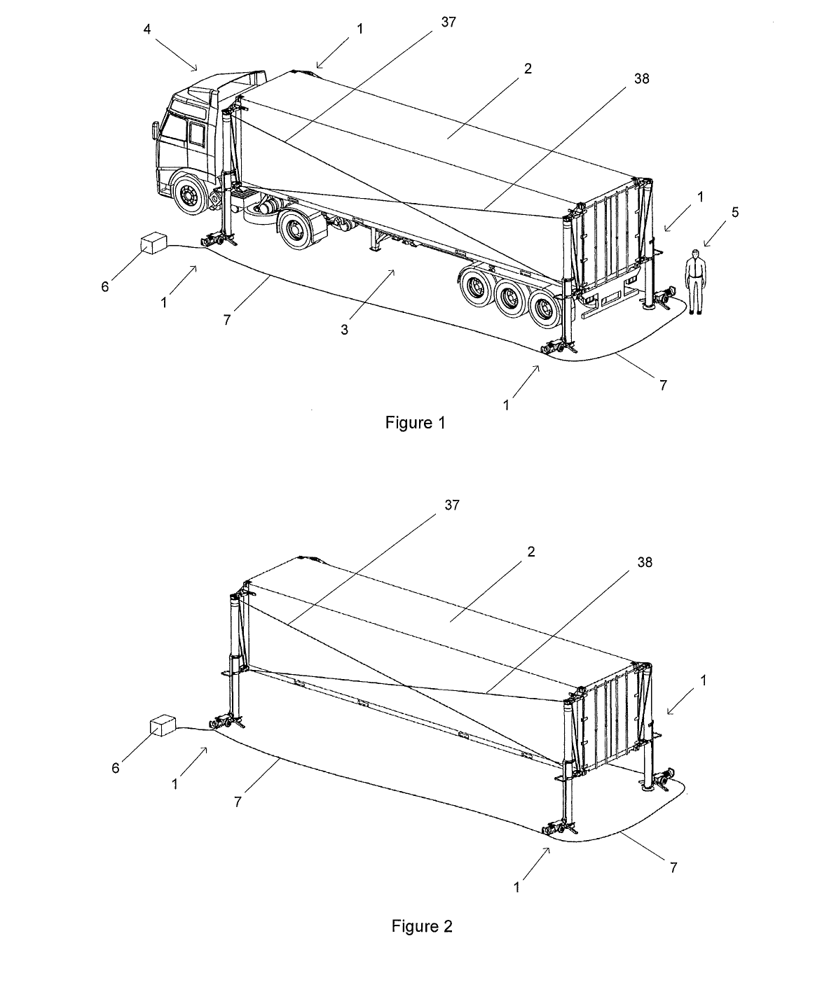

FIG. 1 shows four lifting devices 1 attached to the four corners of a container 2. The container 2 is atop an articulated trailer 3 towed by a truck 4, but could equally be atop any suitable truck or trailer. The scale of the system can be appreciated relative to the height of the operator 5. In the foreground stands a control box 6 with lines 7 running to each individual lifting device 1. Depending on the chosen set-up, the lines 7 may be communications lines, electrical lines or hydraulic lines. The control box 6 may be self-powered (e.g. with a fuel generator) or it may be supplied by an external power supply (not shown).

FIG. 2 shows the lifting devices attached to the container while in the extended position.

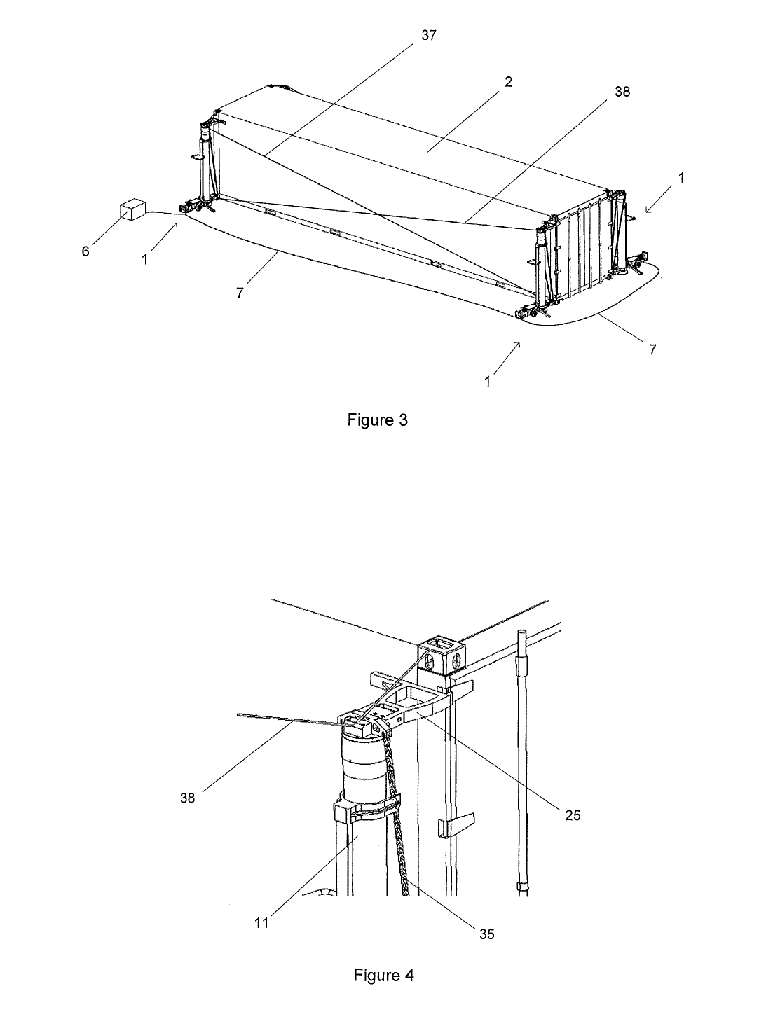

FIG. 3 shows the container 2 at ground level. The lifting devices 1 are retracted.

To reach this configuration, the container has been lifted from the trailer, which has been removed from under the container and the container then subsequently lowered to ground level. Alternatively, this position might be the starting point (following attachment to the container) for lifting the container up from the ground so that a trailer might reverse under it.

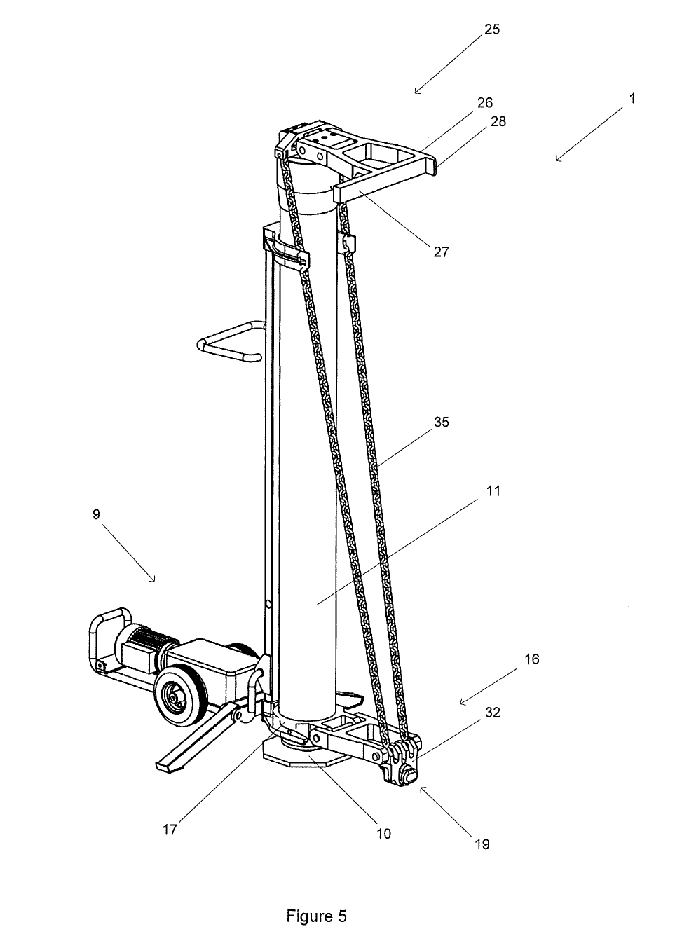

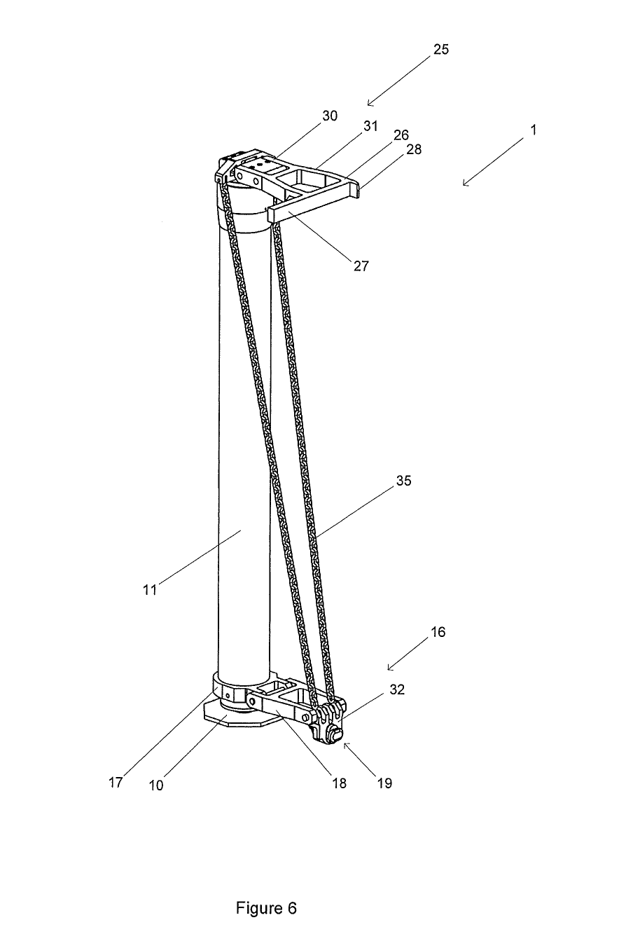

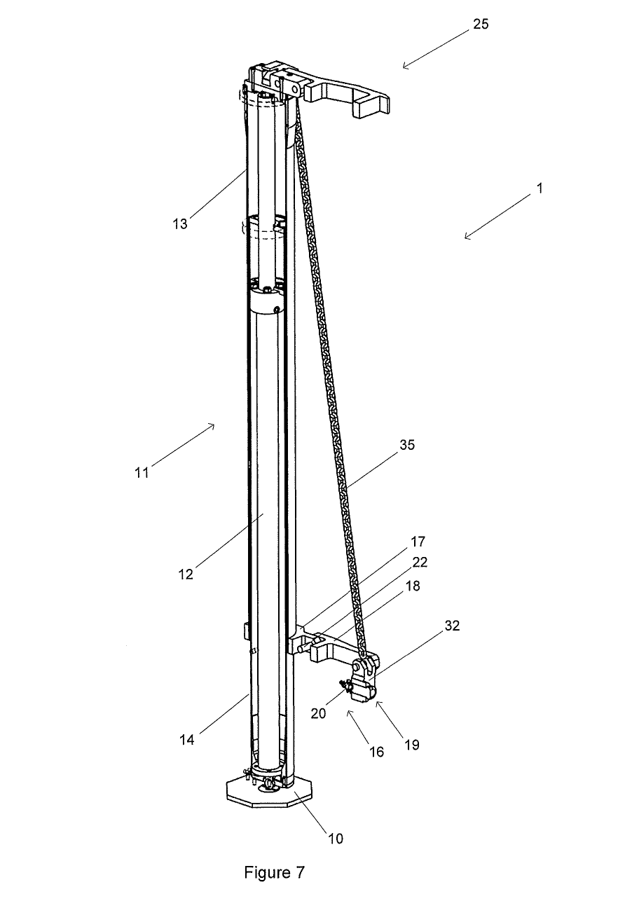

An individual lifting device 1 is shown in FIG. 5. In this embodiment a combined hydraulic power unit 9 and wheeled sub-structure is shown attached to the lifting device 1. However, in other embodiments, such as shown in FIGS. 6 and 7, a hydraulic power unit and wheeled sub-structure is not attached to the lifting device 1. In those embodiments a separate power unit is used.

The lifting device 1 includes a base or footpad 10. An adjustable height column 11 is mounted on and extends upwards from the base 10. As shown in FIG. 7, the adjustable height column is essentially formed by a hydraulic actuator 12 with, optionally, telescoping tube sections 13, 14 surrounding the actuator. As the hydraulic actuator's length changes the tube sections 13, 14 slide along each other.

The lifting device 1 also includes a mounting arrangement 16. The mounting arrangement 16 is mounted at one end 17 to the adjustable height column 11. Preferably the mounting arrangement is positioned at or near a bottom end of the upper telescoping tube section 13. In any case, the mounting arrangement 16 is mounted at a point along the length of the adjustable height column 11 that allows it to be positioned at ground level (as in FIGS. 1, 3, 5 and 6) and to move upwards as the adjustable height column 11 is extended (as in FIGS. 2 and 7).

The mounting arrangement 16 includes a second portion 18 that extends from the first portion 18. It is preferable that this portion 18 is maintained horizontal so that only lateral loading is applied to the bottom end of the adjustable height column. At the end of this second portion a connector 19 is provided. The connector is preferably a twist-lock connector configured to attach to a standard twist-lock fitting at a bottom corner of the shipping container. A suitable handle 20 or actuator may be provided in order to rotate the twist-lock connector after attachment to the container, in order to secure the attachment.

The mounting arrangement therefore provides an attachment to the container that is offset from the axis of the adjustable height column 11.

The second portion 18 may be free to rotate about the first portion 17, for example around a pin 22.

The lifting device 1 also includes an upper container support 25. As shown, the upper container support 25 is preferably a passive support that engages with the corner of the container but does not lock into a twist-lock fitting. This avoids the need for connecting the lifting column 1 directly to the container's upper twist-lock fittings, which may be at a considerable height above the ground.

The upper container support 25 may include a generally corner- or L-shaped section 26 that engages the container corner. The L-shaped section may have a long arm 27 and a short arm 28. In use the long arm may lie against the side of the container, with the short arm against the end of the container, as shown in FIG. 4. The upper container support 25 is mounted at or near a top end of the adjustable height column 11, and includes a first portion 30 mounted to the column 11 and a second portion 31 that extends from the column to the L-shaped section 26. The face of the long arm 27 may lie in approximately the same plane as the face 32 of the lower connector 19, i.e. both lie against the side of the container. The face of the L shaped section 25 is designed to allow it to slide up the side of the container without interference from features on the container such as its door hinges. The face may have plastic pads with a curved top and bottom.

The lifting device 1 also includes a support in the form of a flexible tensile element such as a wire, cable, strap or chain 35 that extends on a diagonal path from the mounting arrangement 16 to the top end of the adjustable height column 11. In some embodiments two or more such supports 35 may be used. In a preferred embodiment a single length of wire, cable, strap or chain 35 is used, with both ends attached to either the top end of the adjustable height column 11 or the mounting arrangement 16. A mid-point of the wire, cable or chain 35 then extends around the other of the top end of the adjustable height column 11 or the mounting arrangement 16. This arrangement requires only two attachments of end points of the wire, cable, strap or chain 35, which reduces weaknesses and costs associated with such attachments.

In use, the weight of the container applies a tension force through the wire, cable, strap or chain 35 to the top end of the adjustable height column 11. As this force is applied at an angle, it tends to force the upper container support 25 in against the side of the container, which is useful in maintaining the correct column position, especially in the absence of locking connection to the top twist-lock fitting. The container therefore forms part of the overall structure of the system. The Applicant's lifting devices are positioned to the side of the container during use (not to the end or diagonally from the corner as in some prior systems), which allows movement of a truck or trailer under the container. This configuration also resists side to side tipping of the container.

In use, the four lifting devices 1 will be positioned at the four corners of the container, and the four connectors 19 attached to the bottom twist-lock fittings at the bottom corners of the container. Optionally one or more security elements may be added to assist with stabilising and bearing some of the weight of the lifting device while it is being attached and detached to and from the container and to assist with maintaining the position of the top of the adjustable height columns 11 as the container is raised. For example, in FIGS. 1 and 2 a number of cables or straps 37, 38 may be used across the diagonals of the container, either to the opposite corner or to a suitable bracing point situated along the length of the container, such as the forklift cavities often found on a 20 foot container. This diagonal bracing helps to prevent longitudinal tipping of the lifting devices 1 and container 2.

Before or after the lifting devices are all in position, the lines 7 and control box 6 may be connected. The system can then be controlled to raise (or lower) the container as required.

The push force required from the four actuators to lift a fully loaded shipping container is relatively low in comparison with the forces that hydraulic systems are capable of delivering.

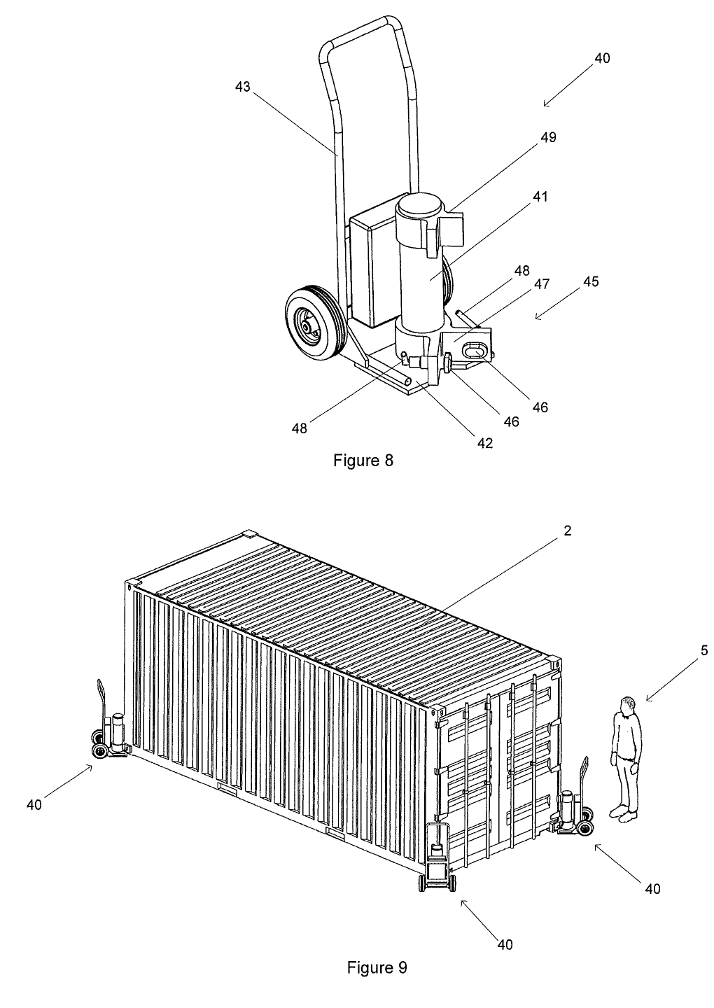

FIGS. 8 and 9 shows a further embodiment of the lifting and/or weighing system 40, that is adapted for use solely as a weighing system. In this embodiment it is only necessary to lift the container a short distance, just far enough that its weight is entirely held by the four lifting devices 40. The adjustable height column 41 may be much shorter than that of FIGS. 1 to 7.

Each lifting or weighing device 40 includes a base 42 on which the adjustable height column is mounted. As shown, the base 42 may be mounted on a wheeled trolley 43 to facilitate movement of the lifting or weighing device 40.

In this embodiment it is also not necessary to allow space for a truck or trailer to move underneath the container. The lifting or weighing devices 40 may therefore be mounted at a 45 degree angle to the container corners (as shown in FIG. 9). However, any suitable orientation may be used.

In the embodiment shown, the lower mounting arrangement 45 includes one or more, preferably two, twist-lock connectors 46 that engage with the twist-lock fittings at the bottom corner of the container 2. The twist-lock fittings may be mounted on a generally L-shaped section 47 and each twist-lock connector may have a corresponding handle 48 allowing rotation of the twist-lock connector 46 to engage with or disengage from the container twist-lock fittings.

The lifting or weighing device may also include an upper support 49 positioned at or near the top of the adjustable height column 41. The upper support may be a simple L-shaped support.

In use, the four lifting or weighing devices 40 will be positioned at the four corners of the container, and the twist-lock connectors attached to the bottom twist-lock fittings at the bottom corners of the container. Once the lifting devices are all in position, they may be operated to lift the container clear of the ground. The weight of the container is then borne entirely by the lifting or weighing devices 40.

Each lifting or weighing device 40 may include a suitable sensor, for example, a pressure transducer for measuring the hydraulic pressure in the actuator, or a load cell. The sensors in the four lifting or weighing devices allow the weight properties of the container to be determined. The total container weight may be determined. Further, the weight distribution within the container may be determined by comparison of the loads detected by the different weighing devices.

Still further, the centre of mass may be determined by altering the container orientation (e.g. by tilting and/or rolling) and measuring loads at different orientations. This may be achieved by a manual or automated sequence of orientation changes and measurements.

An estimate of weight may be obtained using the sensors from a lesser number of lifting or weighing devices.

The lifting or weighing devices may be linked to a controller, for example by a wired or wireless communications link, in order to allow data to be gathered from all four sensors, processed, stored and communicated to other devices or interested parties. The controller may be mounted with one of the lifting or weighing devices or may be a separate unit.

All of the various elements described herein in relation to the larger scale lifting and weighting system, including the electric and hydraulic power supply arrangements, portable sub-structure, container attachment mechanisms, sensors, electronic controls and data storage and communications systems may be scaled down, adapted or dispensed with to reflect the dedicated weighing functionality sought by this embodiment. Further, the weighing function may be provided in all embodiments described herein.

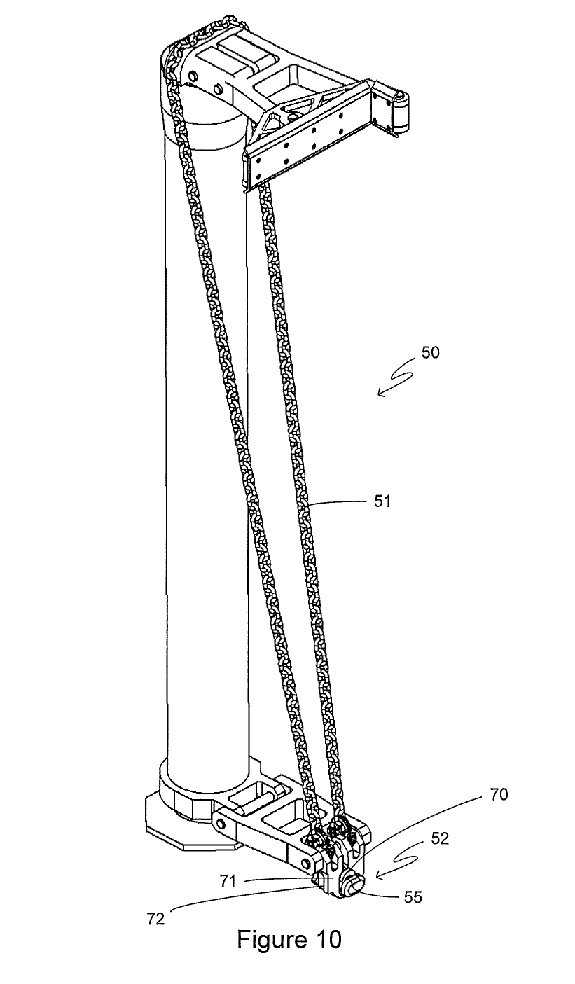

FIGS. 10 to 12 illustrate a further embodiment of lifting device 50. The lifting device 50 is substantially similar to the device 1 of FIGS. 1 to 7. However, here the flexible tensile element 51 is attached at each end to the second portion of the mounting arrangement, with a mid-point of the flexible tensile element extending around the top portion of the column. In an alternative arrangement, the flexible tensile element 51 may be attached at each end to the top portion of the column, with a mid-point of the flexible tensile element extending around the second portion of the mounting arrangement. This arrangement requires only two connections to the two ends of the flexible tensile element, as opposed to the four connections required where two separate lengths of tensile element are used.

As in FIGS. 1 to 7, the flexible tensile element may be a cable, wire, strap or chain.

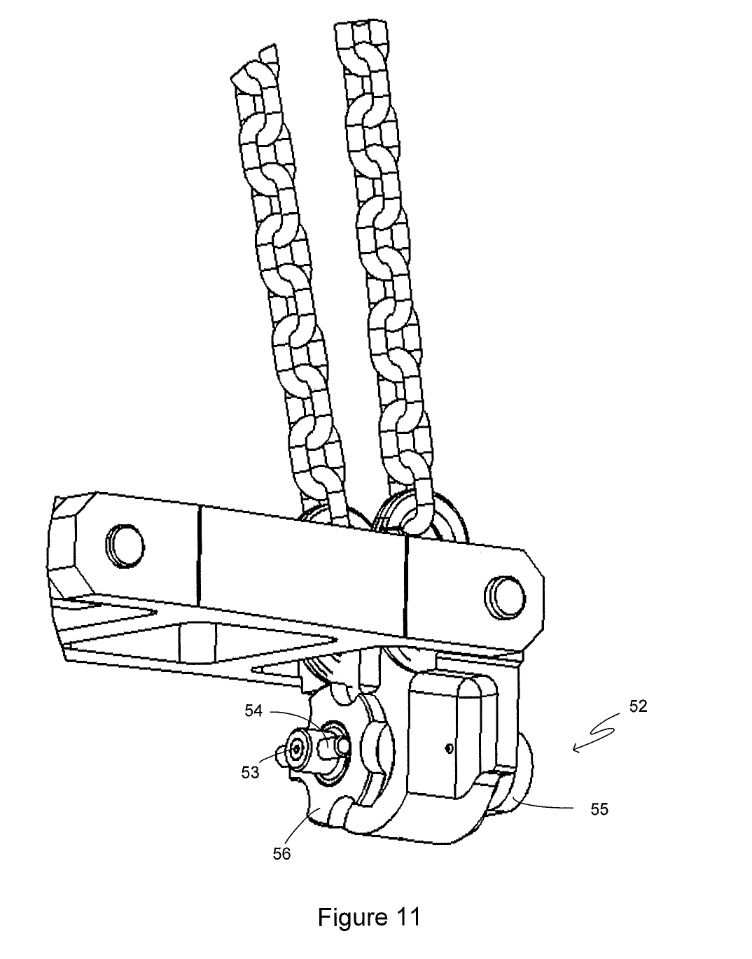

FIG. 11 shows a twist lock fitting 52 in further detail. The twist lock fitting 52 has a T-shaped handle 54 mounted on a shaft 53. The handle may be operated to rotate the twist-lock element 55, generally with the twist lock element 55 positioned within the corner casting of the container. A second handle, in the form of a star-shaped nut 56 acts on a thread to tighten the twist-lock against the container's corner casting. The direction of rotation to tighten the nut is the same as the direction to rotate and lock the twist-lock in the container's corner casting.

There is a mechanical stop at each end of the rotation that limits the amount of rotation of the twist lock element 55 to 90 degrees (from unlocked to locked), i.e. the twist lock element 55 has only 90 degrees of rotation. In one orientation, the twist lock element 55 is at 90 degrees relative to the oval hole in the corner casting, and so is locked. In the other orientation, the twist lock element 55 is aligned to the oval shape of the corner casting and is therefore unlocked.

Further, a protrusion 70 may be provided on face 71 (FIG. 10). This protrusion 70 engages the oval hole in the corner casting of the container and transmits the vertical force required to lift the container.

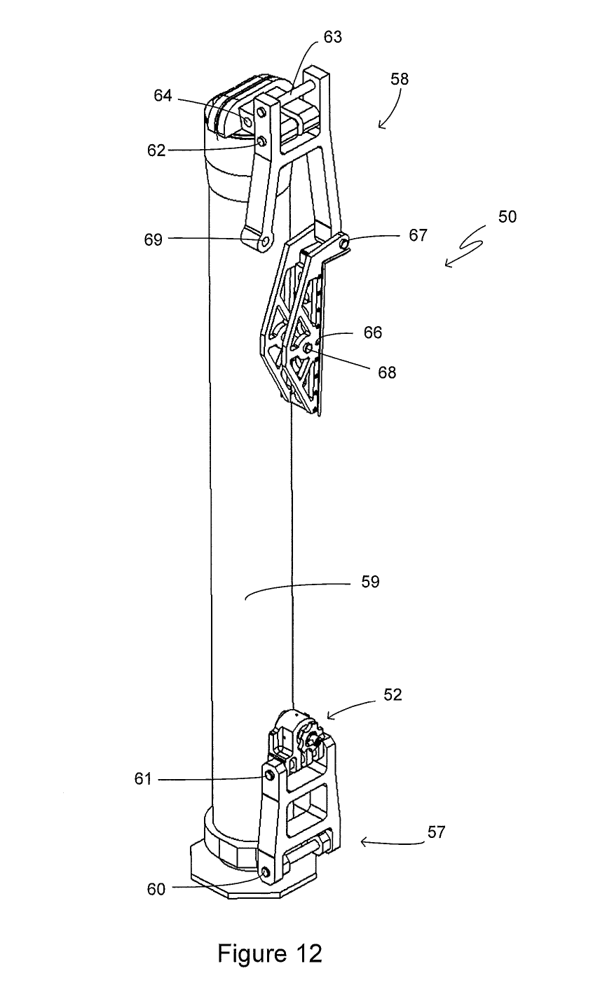

FIG. 12 shows the device 50 in a folded or stowed position, such as might be used for transport or storage of the device 50. In this drawing the flexible tensile element 51 is omitted for clarity. However, the flexible tensile element 51 preferably remains attached in the folded or stowed position.

FIG. 12 shows both the mounting portion 57 and upper container support 58 folded against the column 59 of the lifting device 50. The mounting portion 57 folds upwards around pivot 60, with the twist-lock fitting 52 also free to rotate about pivot 61. The pin 61 connects three elements: the second portion of the mounting element, the twist lock portion (including base 72 and twist lock fitting 52) and the flexible tensile element 51. The connection points are preferably double shear. In combination, this provides very efficient loading.

The upper container support 58 rotates about pivot 62. This rotation is allowed by removal of the pin 63, which in the position of FIG. 10 is received in bore 64 to secure the upper container support in position. Further, the L-shaped section 66 may rotate about pivot 67, after removal of pin 68, which in the position of FIG. 10 is received in bore 69.

The flexible tensile element 51 allows the mounting arrangement to move to this folded position without any disconnection of the flexible tensile element being required.

In any of the above embodiments, height, position, load and hydraulic pressure sensors may be provided in each lift or weighing unit. In addition to the other functions described herein, the sensors provide data to a controller for use in operating the lifting or weighing devices. For example, a controller may automatically control the lift or weighing units to move the container in a desired manner. This may involve synchronous operation of the lifting units to lift or lower the container smoothly. Further, the controller may automatically control the lift or weighing units in order to vary the orientation of the container, for example in order to allow load measurements to be made at various container orientations.

System limits may be set, particularly for safety purposes. For example, a maximum container tilt may be set.

The controller may also monitor the lift units and record system performance for diagnostic purposes. For example, the controller may monitor hydraulic pressures, thereby detecting faults such as low pressure. Or the system may, for example, provide data to inform an investigation following a breakdown or accident.

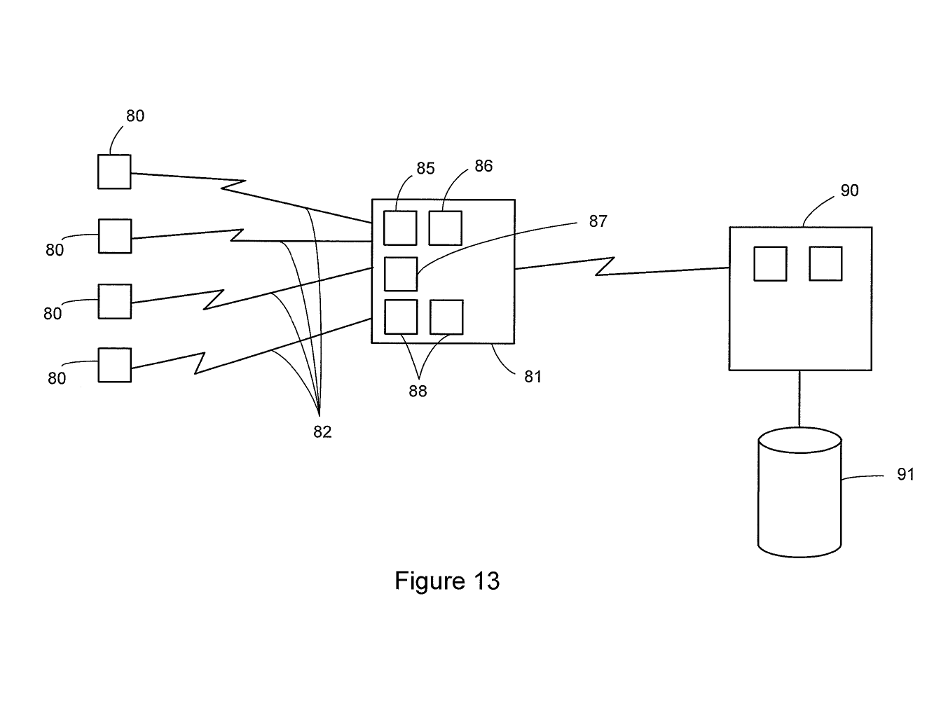

FIG. 13 shows one embodiment of the control system. Four lift or weighing units 80 communicate with a local controller 81 over wireless communication links 82. Each lift or weighing unit includes a number of sensors and actuators, as discussed above. The local controller 81 may, for example, be fixed to a truck or trailer, but is preferably in the form of a handheld control device. The local controller may be any suitable device, including a Smartphone, tablet, laptop or similar device. The local controller 81 includes a processor 85, memory 86, a display 87 and one or more user input devices 88. The user input devices allow an operator to instruct raising, lowering and/or weighing of the container. However, once instructed the raising, lowering and weighing processes may be substantially automated. Each element of the system may be equipped with suitable communications equipment, such as wireless receivers and/or transmitters.

The local controller may communicate with a remote computer 90, such as a transport company computer system, server or cloud storage. Information regarding the container can therefore be transmitted to the computer 90 and stored in a database 91.

Data may be gathered from the devices by a wired or wireless connection and may be transferred from the local controller to the remote computer, storage or database by any suitable communications link.

Any suitable arrangement of controllers and/or subcontrollers may be used. For example, a single subcontroller may be provided in each weighing unit and communicate with a local controller.

In some embodiments the controller may perform only limited or no control function over the lifting movement and be provided solely for gathering, processing and/or displaying data from the system.

The data transfer from the weighing system may be aided with an “app” running on a “Smartphone” or other similar device. The weight data may be supplemented with data collected by the smart device itself or input by the user, for example time, date, location (e.g. via GPS), container ID, container seal number, cargo information, shipping information, name of shipper, and photos related to the container and/or its cargo.

The system may include information technology systems that enable system diagnostics and/or firmware upgrades to be performed either physically or remotely.

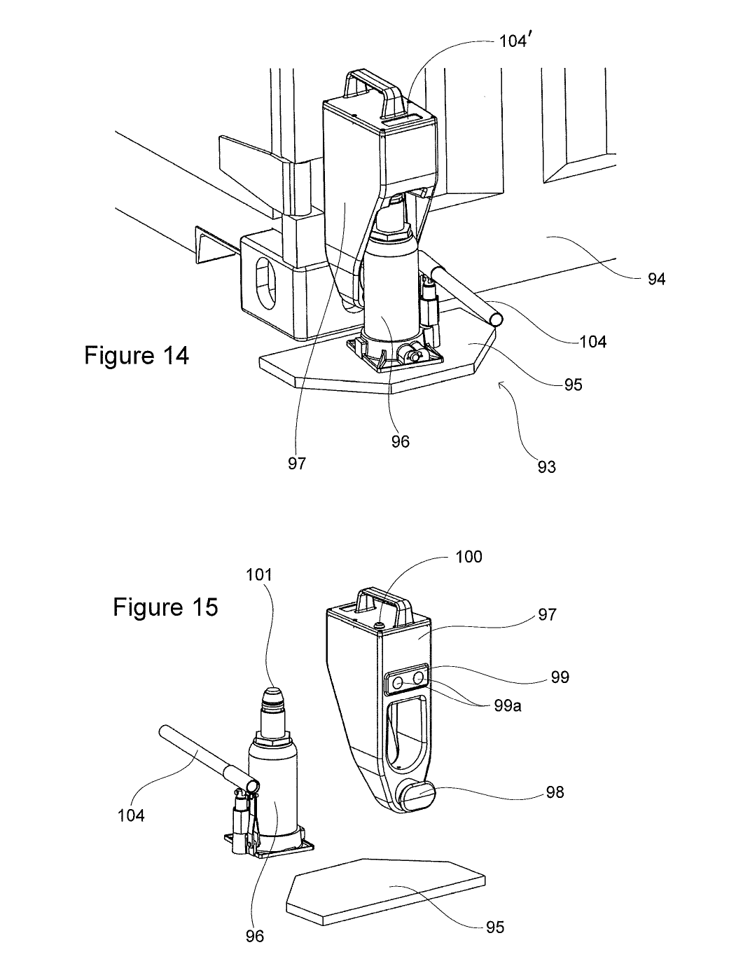

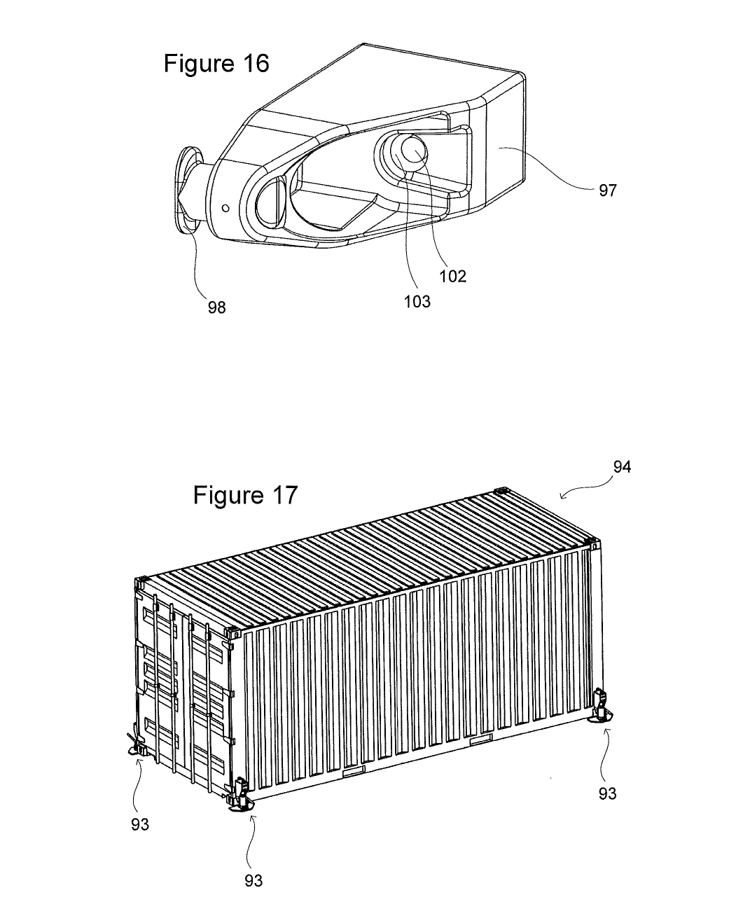

FIGS. 14 to 17 show a further embodiment, in which the devices are configured to lift a shipping container 94 a short distance above ground level. The devices 93 are primarily intended for weighing the shipping container and may include any appropriate sensors, controllers etc as described above. In particular the devices may include sensors and control arrangements as discussed above in relation to the embodiment of FIGS. 8 and 9.

As shown in FIGS. 14 and 15, each device 93 includes a base 95, an adjustable height element in the form of a linear actuator 96 (such as a hydraulic cylinder) and an engagement element in the form of a mounting bracket 97. The base 95 may be formed integrally with the actuator 96, or may be a separate element. The mounting bracket in this embodiment may be a separate component, which is first engaged with the container and then receives an upper end of the actuator 96.

The mounting bracket 97 includes a twist lock fitting 98 and a support element 99 which bears against the side of the container. The support element may include one or more magnets 99a which assist with attachment of the mounting bracket as they are attracted to the wall of the container. In some embodiments the twist lock fitting 98 may be fixed. In use, the twist lock fitting 98 may be engaged with the corresponding fitting of the container and the entire mounting bracket may then be rotated through 90 degrees to the vertical position, simultaneously bringing the mounting bracket to the operating position and locking the twist lock fitting, but still allowing free rotation of the mounting bracket about the twist lock fitting 98. The weight of the container and the upwards force from the actuator 96 therefore act together to self-align the device 93. This ensures that the load cell (to be described below) is aligned with the gravity vector, providing greater measurement accuracy. The device 93 may be provided with an alignment device to aid or confirm correct alignment, such as a spirit or bubble level 100 (FIG. 15).

Once the mounting bracket is in position the actuator 96 is positioned as shown in FIG. 14. In this embodiment, an upper end 101 of the actuator 96 engages with a load cell 102. The upper end 101 of the actuator 96 and a housing 103 surrounding the load cell 102 cooperate to align the actuator 96 and mounting bracket 97. In the embodiment shown this arrangement is generally in the form of a ball and socket joint. This alignment ensures that the load cell 102 is properly aligned to give accurate weight readings. Weight readings (weight measured by an individual weighing unit, total container weight etc) may be displayed on a display 104′ (FIG. 14).

In the embodiment shown the actuator is a hydraulic cylinder with a manually operated handle 104. However, any suitable actuator may be used.

The weighing units may be upon or integrated with a pedestal that allows a container that is elevated (e.g. upon a trailer) to be weighed. As with the grounded weighing units, the weighing units only need to lift the container a short height clear of the structure they are resting on in order to get a weight measurement. When the supporting structure is a trailer, this may require slight extra lifting height to compensate for the travel of the trailer's suspension.

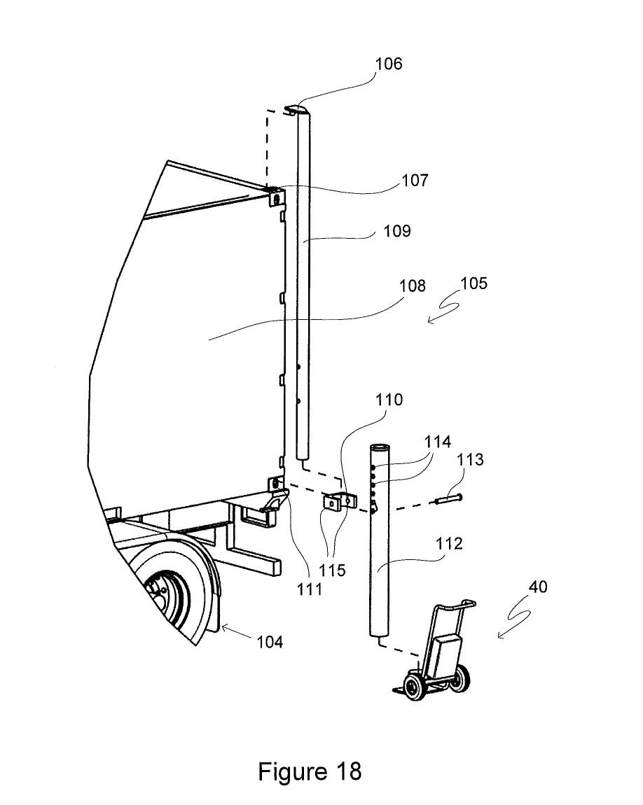

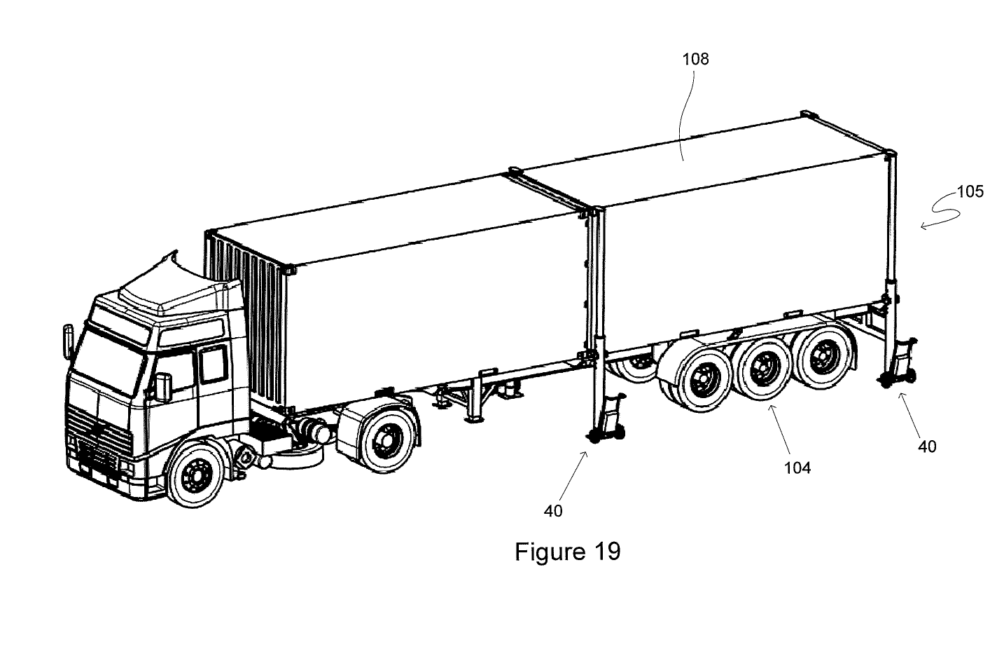

FIGS. 18 and 19 illustrate an alternative lifting and/or weighing system. This system may be especially suited as a dedicated weighing system configured for weighing a container on a trailer. Again, the weighing units only need to lift the container a short height clear of the structure they are resting on in order to get a weight measurement. In this case the required height is provided by extension elements 105. Each extension element 105 includes an upper bracket 106 configured to engage with an upper fitting 107 of the container 108. An upper upright element 109 extends down the corner of the container 108. A lower bracket 110 engages with a lower fitting 111 of the container 108 and receives a lower upright element 112 in a height adjustable manner, with a pin 113 passing through one of the holes 114 in the lower upright element 112 and holes 115 in the lower bracket 110. The upper upright element 109 has a diameter less than the internal diameter of the lower upright element 112.

In use an operator will position a weighing unit 40, which may be similar to that of FIGS. 8 and 9, at ground level below each corner of the container 108. The lower bracket 110 may be attached to the lower fitting 111 of the container 108. The lower upright element 112 may then be positioned on the upper end of the adjustable height element of weighing unit 40 and positioned within the lower bracket 110. The pin 113 may then be inserted, The upper upright element 109 may now be lowered into the top end of the lower upright element 112 until the upper bracket 106 engages with the upper fitting 107.

The extension element 105 therefore engages with both upper and lower fittings 107, 111, providing a stable mounting of the weighing unit 40 to the container 108. This arrangement also allows the same weighing unit 40 to be used to weight containers at ground level and containers positioned on a trailer, truck bed, loading platform or any other raised structure.

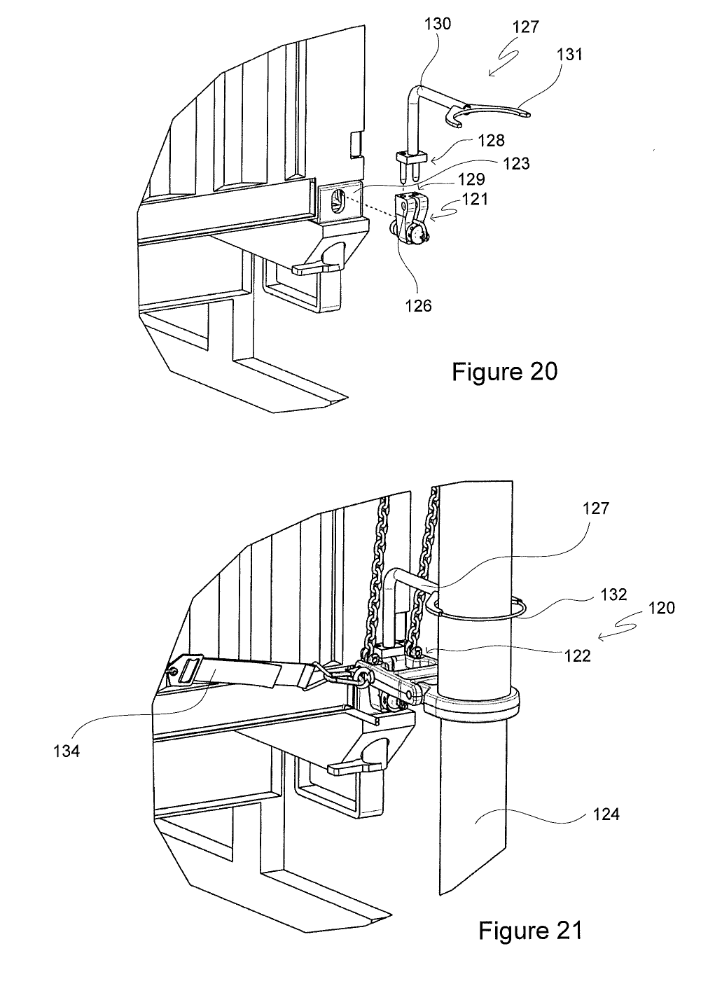

FIGS. 20 and 21 show a further embodiment of lifting and/or weighing device 120. In this embodiment a connector 121 is detachable from the rest of the mounting arrangement 122. The connector can therefore be attached to the container fitting 123 before attaching the adjustable height column 124 via the mounting arrangement 122 to the connector 121. This attachment may be made via a pin received in hole 126 in the connector 121 and cooperating holes in the mounting arrangement 122.

In this embodiment a support 127 may also be mounted on the connector 121. The support 127 may include a mounting portion 128 configured to engage with cooperating mounting elements 129 on the connector 121. The support 127 includes an arm 130 extending from the mounting portion 128 to a support element 131. The support element 131 receives the adjustable height column 124 as shown in FIG. 21. A chain, wire, cable or other closure 132 may be attached to the ends of the support element 131, such that the adjustable height column 124 is enclosed.

In use, an operator may attach the connector 121 and support 127 to the container. The operator may then position the base of the lifting and/or weighing device, align the adjustable height column 124 with the support element 131 and secure the closure 132. In this position the lifting and/or weighing unit is supported against tilting or toppling during further installation steps. The height of the adjustable height column can now be adjusted as necessary and the pin can be introduced through the cooperating holes in the mounting arrangement 122 and connector 121. The lifting or weighing device 120 is then ready for operation.

This arrangement assists in stabilising the lifting and/or weighing device while attaching or detaching the device from the container. It is especially useful when the container is at a raised height, for example trailers being loaded onto or unloaded from trailers.

FIG. 21 also shows a flexible tensile element 134 (such as a cable, wire, strap or chain) attached to the mounting arrangement 122, providing additional bracing between the devices 120, in a similar manner to that described above.

While the embodiments discussed above generally include fittings for engaging with the standard twist lock fittings used in containers, in other embodiments the Applicant's devices may attach to the container at the forklift pockets generally provided at the bottom of the container, or may attach to any other standard fitting of a shipping container.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. A shipping container weighing system, including a plurality of portable weighing units, each weighing unit including:
i. a base;
ii. an engagement arrangement configured to engage with a shipping container;
iii. an adjustable height element mounted on and extending upwards from the base, the engagement arrangement being mounted on the adjustable height element, wherein the adjustable height element can be driven to extend in order to lift the container;
iv. a sensor configured to sense load or force applied to the weighing unit by the shipping container when it is supported by the portable weighing units.

2. A system as claimed in claim 1 wherein the adjustable height element includes a linear actuator.

3. A system as claimed in claim 2 wherein the linear actuator is a hydraulic actuator.

4. (canceled)

5. (canceled)

6. A system as claimed in claim 1 including a controller.

7. A system as claimed in claim 6 wherein the controller is configured to determine one or more weight properties of the container.

8. A system as claimed in claim 7 wherein the weight properties include one or more of: weight sensed by the individual weighing units, total container weight, weight distribution, and centre of mass.

9. A system as claimed in claim 6 wherein the controller is configured to associate container weight data with one or more of: time, date, location, container ID, container seal number, cargo information, shipping information, name of shipper, and image data.

10. A system as claimed in claim 6 wherein the controller is configured to transmit gathered data to a remote computer, database or cloud storage.

11.-14. (canceled)

15. A system as claimed in claim 6 wherein the controller is or includes a wireless handheld control unit.

16. A system as claimed in claim 6 wherein the controller is configured to implement a verification process in order to verify that weight data has been properly obtained without tampering.

17. In a container lifting and/or weighing system, an engagement arrangement including:
i. a first engagement element configured to engage with a standard fitting or fittings of a shipping container;
ii. a second engagement element configured to receive, in use, an upper end of an adjustable height element such that, in use, the adjustable height element can be driven to extend in order to lift the container; and
iii. a sensor configured to sense load or force applied by the shipping container when it is supported by the engagement arrangement.

18. An engagement arrangement as claimed in claim 17, wherein the sensor is mounted in the second engagement element.

19. An engagement element as claimed in claim 18, wherein the second engagement element includes a housing configured to receive the upper end of the adjustable height element and to align the upper end of the adjustable height element with the sensor.

20. A system including an engagement element as claimed in claim 17 and a controller.

21. A system as claimed in claim 20 wherein the controller is configured to determine one or more weight properties of the container.

22. A system as claimed in claim 21 wherein the weight properties include one or more of: weight sensed by the individual weighing units, total container weight, weight distribution, and centre of mass.

23. A system as claimed in claim 20 wherein the controller is configured to associate container weight data with one or more of: time, date, location, container ID, container seal number, cargo information, shipping information, name of shipper, and image data.

24. A system as claimed in claim 20 wherein the controller is configured to transmit gathered data to a remote computer, database or cloud storage.

25. A system as claimed in claim 20 wherein the controller is or includes a wireless handheld control unit.

26. A system as claimed in claim 20 wherein the controller is configured to implement a verification process in order to verify that weight data has been properly obtained without tampering.

27.-52. (canceled)
